(19) United States
(12) Patent Application Publication
(10) Pub. No.: US 2004/0104887 A1
(43) Pub. Date: Jun. 3, 2004

(54) Haptic interface device

(75) Inventors: Kazuyuki Tsukamoto, Ashigarakami-gun (JP); Katsumi Sakamaki, Ashigarakami-gun (JP); Shin Takeuchi, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/383,533

(22) Filed: Mar. 10, 2003

(30) Foreign Application Priority Data
Nov. 29, 2002 (JP) 2002-348418

(51) Int. Cl. G09G 5/00

(52) U.S. Cl. 345/156

(57) ABSTRACT

An encased driving section includes magnets provided on a bottom surface in such a manner that their polarities are alternately oriented, a movable frame which is contained in the case and to which coils are attached, and an operating member fixed on the frame. When a state sensor unit senses a state of a vehicle or outside the vehicle, such as omission to turn off lights and the direction of wind, a control section determines whether or not the sensed state should be indicated to an operator and, when it determines that the information should be indicated, passes an electric current through the coils in a predetermined direction to drive the driving section in order to communicate the information to the operator through a haptic stimulus. The haptic interface device can communicate various information to the operator through their sense of touch.

### BACKGROUND OF THE INVENTION

1. Field of the Invention

The present invention generally relates to a haptic interface device, and more particularly relates to an apparatus for indicating conditions of the vehicle or circumstances outside the vehicle to an operator, such as the driver, by providing haptic sensations. The apparatus may be mounted in the vehicle by attaching an operating member to the steering wheel of the vehicle.

2. Description of the Related Art

The driver of a typical vehicle views an instrument panel to obtain information on the conditions of the vehicle such as the fuel level, and looks at signs, information boards, or the display of a navigation system on which traffic information is displayed to know circumstances outside the vehicle, such as an obstacle ahead or conditions of a road surface, while operating the vehicle. Although the driver can visually perceive a great deal of information, because the driver should concentrate on driving the vehicle, he or she cannot devote continuous attention to the information provided and may, depending on circumstance, miss significant or helpful information.

To compound the problem, in recent years, many vehicles have been equipped with sophisticated audio and navigation systems. As these devices have grown more sophisticated, the number of operating switches has increased, and they have caused more eyestrain.

A growing amount of information is being provided from on-vehicle equipment and sources outside the vehicle. Because most of this information is visually perceived, a significant burden, perhaps even strain, is placed on the eyes of the driver. It is therefore desirable to provide an apparatus capable of providing information through other than visual means.

### SUMMARY OF THE INVENTION

The present invention was made to solve the problem and advantageously provides a haptic interface device capable of providing various information to an operator in a form intuitively perceivable through their haptic sense, without the help of vision.

To achieve this advantage, a haptic interface device according to the present invention comprises state sensing means for sensing at least one of a state of a vehicle and a state outside the vehicle; indication control means for determining whether or not information sensed by the state sensing means should be indicated to an operator and generating haptic information representing the information when it determines that the information should be indicated to the operator; and haptic presentation means capable of motion based on the haptic information provided from the indication control means.

According to the present invention, the status inside or outside a vehicle can be provided to an operator through his or her haptic sense without help of vision. In particular, information to be indicated to the operator can be intuitively communicated to the operator by driving the operating member in a direction that relates to the information to be indicated to the operator.

The haptic presentation means may have two or more degrees of freedom of movement.

When the operating member can be moved through two or more degrees of freedom, a more intuitive haptic stimulus that corresponds to information to be provided can be generated.

According to another aspect, the present invention provides a haptic presentation means comprising a base member; an operating member to be operated by the operator; a moving member movably attached to the base member and to which the operating member is fixed; and operating member drive control means for driving the operating member to at least two degrees of freedom by moving the moving member; and the operating member drive control means controls the moving member in a movement pattern according to information to be provided to the operator.

The haptic interface device according to the present invention may further comprise immobilization means for forcibly immobilizing said moving member when a condition which may require strong gripping of a steering wheel on which the haptic interface device is installed is detected.

Because the moving member is forcedly immobilized when the haptic interface device attached to the steering wheel determines that a condition has occurred in which the driver is required to strongly hold the steering wheel, the holding power of the driver can be sufficiently transmitted to the steering wheel.

Furthermore, the immobilization means may have a lock mechanism for physically inhibiting a movable state of the moving member.

The operating member drive control means may be designed to drive the operating member in a direction relating to information to be indicated to the operator through the haptic information.

The state sensing means may comprise an information receiving unit for receiving traffic information, such as information sent from a provider, as a state outside the vehicle.

### BRIEF DESCRIPTION OF THE DRAWINGS

FIG. 1 is a schematic perspective view of one embodiment of a haptic interface device according to the present invention;

FIG. 2 is a plan view of the haptic interface device shown in FIG. 1 with the top of its housing removed;

FIG. 3 is a side elevation view of the haptic interface device shown in FIG. 2;

FIG. 4 is a perspective view of a haptic interface device according to the first embodiment installed under a vehicle steering wheel;

FIG. 5 is a functional block diagram of the haptic interface device according to the first embodiment;

FIG. 6 is a plan view of a haptic interface device according to a second embodiment of the present invention with the top of its housing removed;

FIG. 7 is a side elevation view of the haptic interface device shown in FIG. 6;

FIG. 8 is a schematic perspective view of a haptic interface device according to the present invention;

FIG. 9A shows a physical relationship between a coil and a magnet in the haptic interface device shown in FIG. 8 viewed from above;

FIG. 9B shows a side elevation view of the haptic interface device with a part of its housing removed; and

FIG. 10 is a schematic perspective view of a variation of the haptic interface device shown in FIG. 8.

### DESCRIPTION OF THE PREFERRED EMBODIMENTS

Preferred embodiments of the present invention will now be described with reference to the drawings.

First Embodiment

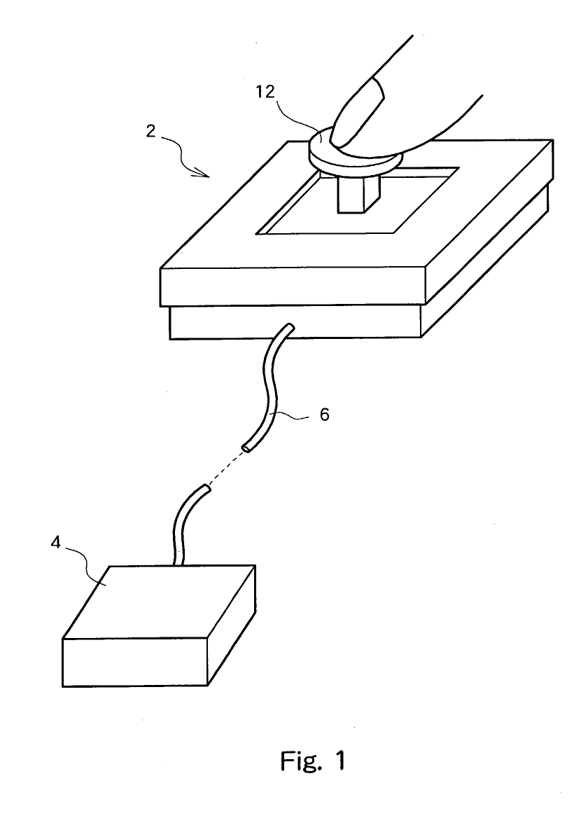

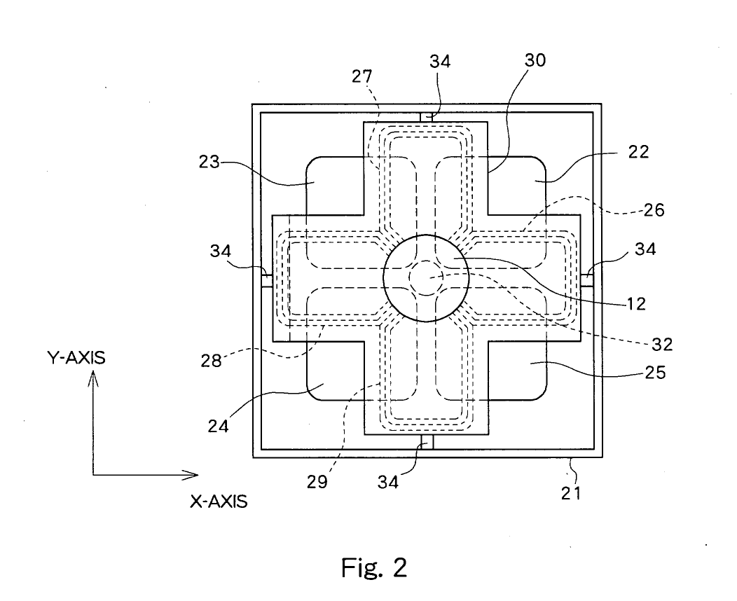

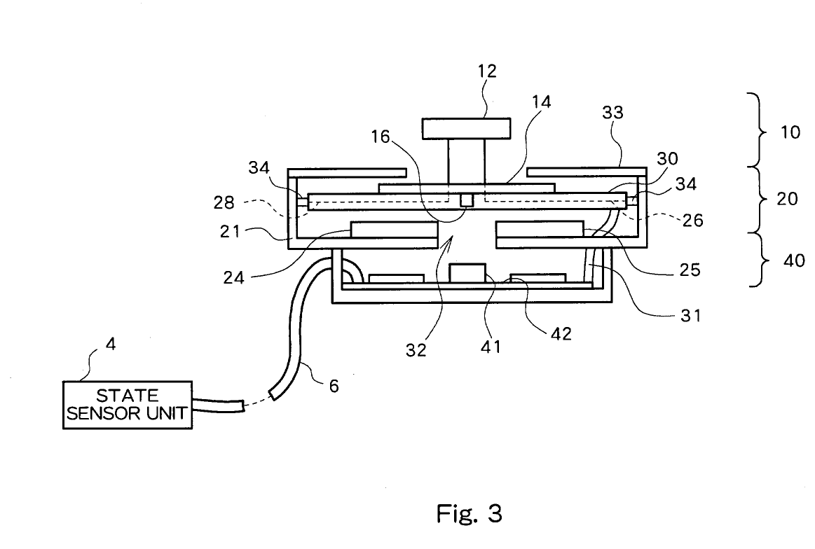

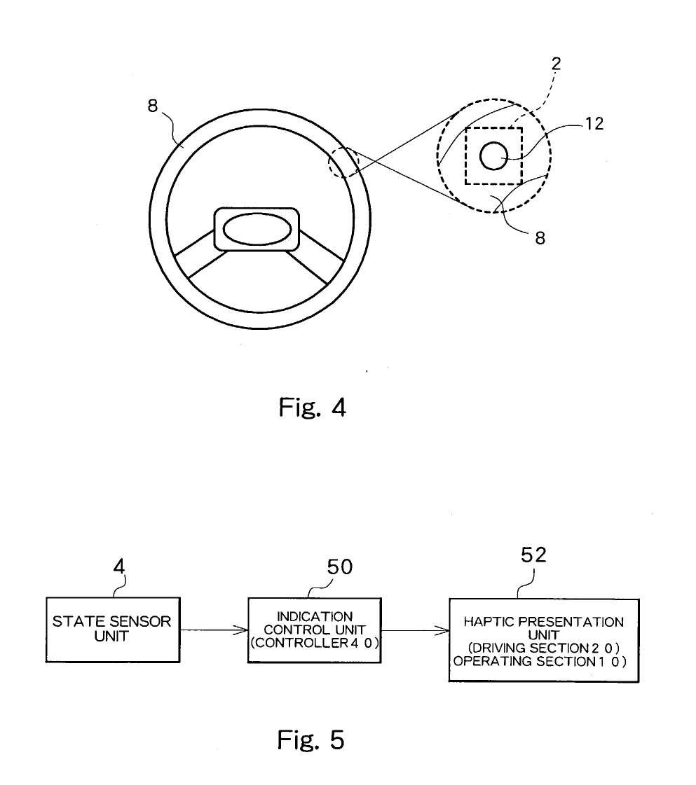

FIG. 1 shows a simplified perspective view of one embodiment of a haptic interface device according to the present invention. FIG. 2 is a plan view of the haptic interface device shown in FIG. 1 with the top of its housing removed. FIG. 3 is a side elevation view of the haptic interface device shown in FIG. 2. FIG. 4 shows the haptic interface device 2 installed in the underside of a vehicle steering wheel.

Shown in FIG. 1 are the main unit of the haptic interface device 2 of the present embodiment and a state sensor unit 4, which is provided separately from the main unit and connected with the main unit through a connection line 6. The main unit of the haptic interface device 2 is installed in the underside of the steering wheel 8, with only an operating member 12, which is operated by an operator (typically a driver of the vehicle), projecting from the steering wheel 8. The state sensor unit 4 consists of various sensors for sensing the state of the vehicle. The state of the vehicle represents an event or a current condition which should preferably be indicated to the driver, such as, for example, vehicle lights being left on, fuel running low, or low tire pressure. Basically, the phenomena are those at an alert level or higher. For example, the state sensor unit 4, which has an illumination meter that senses light intensity outside the vehicle to sense an on-state of lights, detects light intensity exceeding a reference intensity and, if lights stay on for a predetermined period of time or longer, sends a signal indicating a possible “failure to turn off lights”. The state sensor unit 4 may also include fuel level sensing means and tire pressure sensing means for the case of fuel shortage and tire pressure decrease and, if the fuel level or tire pressure decreases below a predetermined amount or pressure, sends a signal indicating the “fuel low” or “tire pressure low”. In this way, the state sensor unit 4 includes one or more sensors, depending on the vehicle information to be indicated. If an event can be sensed by a sensor provided as a factory-installed component of the vehicle, such as a fuel level indicated by an alert indicator lamp on the instrument panel, output from that factory-installed sensor may be shared. Alternatively, the state sensor unit 4 may be arranged so as to be able to obtain required information from on-vehicle electronic controllers into which sensor signals are input from various sensors. The state of the vehicle detected by the state sensor unit 4 configured as described above is input into the main unit of the haptic interface device 2 via the connection line 6. When, as is not uncommon, the state sensing means is provided in a place other than the steering wheel, the connection line 6 is routed into the steering post. The haptic interface device in the present embodiment comprises the main unit embedded in the steering wheel 8 and the state sensor unit 4 connected to the main unit through the connection line 6, as can be seen from the description above. However, for simplicity, the main unit of the haptic interface device excluding the state sensor unit 4 and connection line 6 will be simply referred to as a haptic interface device in the following description unless otherwise stated.

The haptic interface device 2 embedded in the steering wheel 8 can be roughly divided into an operating section 10, a driving section 20, and a control section 40 as shown in FIG. 3. The operating section 10 includes an operating member 12 operated by an operator. A light emitter 16 that emits light in the opposite direction of the operating member 12 is attached in the center of a base 14 supporting the operating member 12. The light emitter 16 is not shown in FIG. 2 for clarity.

The driving section 20 provides an electromagnetic driving force to the operating member 12 in order to provide a reactive force to the operator operating the operating member 12. The driving section 20 includes magnets 22, 23, 24, and 25 disposed on the bottom surface of a case 21, which provides the base for the magnets, in such a manner that their polarities are alternately oriented. The magnets 22-25 are polarized in the thickness direction of the device 2 so that a magnetic field is generated between adjacent magnets. Coils 26, 27, 28, and 29 and a frame 30 in which the coils 26-29 are mounted are provided over the magnets 21-25 in such a manner that the coils 26-29 are located between the magnets 21-25. An electric current is passed through the coils 26 and 28, which are provided in parallel along the X-axis in a magnetic field, in a predetermined direction according to Fleming's left-hand rule to drive the movable frame 30 along the Y-axis. Similarly, an electric current is passed in a predetermined direction through the coils 27 and 29, which are provided in parallel along with the Y-axis to drive the frame 30 along the X-axis. Accordingly, the frame 30 can be moved along a one-dimensional axis by passing a current through one of the pairs of coils, or moved in two dimensions expressed by a vector sum of one-dimensional directions by passing a current through both of a pair of coils. In this way, the driving section 20 has a structure in which the frame 30 is provided as a moving member in the center of the case 21. The base 14 of the operating section 10 is mounted on the frame 30. An opening 32 is formed in the center of the frame 30 so that the light emitter 16 mounted on the base 14 is not covered with the frame 30. The control section 40, which will be described later, causes a current to pass through the coils 26-29 via a signal line 31 to control the driving section 20 to move the frame 30. The operating member 12 mounted on the frame 30 moves together with the movement of the frame 30. The driving section 20 electromagnetically provides a driving force to the operating member 12 under the control of the control section 40 in order to give a reactive force to the operator. The driving section 20 may be implemented by a two-dimensional actuator described in Japanese Patent Laid-Open Publication No. 2000-330688, for example.

Light emitted from the light emitter 16 and passing through the opening 32 is received by a photosensor 41. The photosensor 41 detects the amount of movement of the operating member 12 based on a direction from which the light is detected. Therefore, the opening 32 should be sized so as not to inhibit light from traveling within the range of movement of the operating member 12. The photosensor 41 may detect the movement of the operating member 12 based on a position irradiated with light and the intensity of light in addition to the direction in which the light is detected. The range of movement of the operating member 12 is the same as the range in which the light can be detected by the photosensor 41. In practice, the range of movement is determined by the size of the opening area in the surface 33 of the housing. The surface 33 of the housing forms a part of the surface of the steering wheel 8 and therefore is rounded in conformity to the shape of the steering wheel 8. Alternatively, the top plate of the case 21 forming the surface 33 is removed so that the driving section 20 is covered with a member forming the steering wheel 8.

The haptic interface device 2 of the present embodiment is attached to the steering wheel 8 in an upright position as shown in FIG. 4. Therefore, the control section 40 should control the driving section 20 in consideration of the weight of the frame 30 and the operating section 10. In order to support the moving part in a rest condition and to account for the vibration normally generated during driving the vehicle, the four sides of the frame 30 are fixed to the case 21 with an elastic member 34 such as a rubber member or spring in the present embodiment.

The control section 40 includes a control substrate 42 that has a control circuit acting as indication control means therein, and the above-described photosensor 41 provided on the control substrate 42. The photosensor 41 senses light emitted from the light emitter 16 to detect the position of the operating member 12 within its moving range, as described above. Detection means according to the present embodiment includes the photosensor 41 and a detection circuit (not shown) provided on the control substrate 42 for detecting an operation performed by the operator on the operating member 12. The control circuit determines whether or not a state of the vehicle detected by the state sensor unit 4 should be indicated to the operator. When the control circuit determines that the state should be indicated, it generates haptic information representing the state of the vehicle and controls the driving section 20 based on the haptic information. This provides haptic information to the driver who touching the operating member 12 and informs them of the state of the vehicle.

According to the present embodiment, the control section 40 is provided below the driving section 20 as shown in FIG. 3, allowing the haptic interface device 2 to be treated as a single component. However, when the configuration of the steering wheel or column is such that the component having the unit shape as shown in FIG. 3 cannot be fit inside the steering wheel 8, the control section 40 may be attached to a side of the driving section 20 or may be separated from the driving section 20, contained in a separate housing, and arranged side by side with the driving section 20 so that it can be contained in the steering wheel 8. In any case, the photosensor 41 should be located in a position where it can receive light emitted by the light emitter 16.

FIG. 5 shows a functional block diagram of the haptic interface device according to the present embodiment. The state sensor unit 4 is means for sensing a state of the vehicle, such as the fuel level. The indication control unit 50 is implemented by the control section 40, determines whether the state of the vehicle sensed by the state sensor unit 4 is information to be indicated to the driver and, if so, generates the information as haptic information. The haptic information is information for indicating to the driver information about the vehicle, such as a possible failure to turn off lights or low fuel level. This information is communicated by motion, such as vibration, of the operating member 12. More specifically, in the present embodiment, drive control information for the driving section 20 causes the operating member 12 to generate motion such as vibration. A haptic presentation unit 52 is implemented by the driving section 20 and operating section 10 and operates based on haptic information sent from the indication control unit 50.

An example operation according to the present embodiment will be described below.

The state sensor unit 4 continuously monitors the status of the vehicle based on signals from the sensors. If the illumination meter senses that the light intensity of lights is higher than a predetermined reference light intensity and that the lights have been in the on-state for a period of time longer than a predetermined period, for example, it determines the state as a possible “failure to turn off lights” and sends a signal indicating such.

When the state of the vehicle is indicated by the state sensor unit 4 via the connection line 6, the control section 40 determines whether it should generate haptic information. For example, when an operation disable mode of the haptic interface device 2 is selected by the operator using a mode selection mechanism, which is not shown, or when the operator is making a sharp turn by turning the steering wheel 8 far in one direction, the control section 40 does not generate haptic information and the operating member 12 does not move. Furthermore, after the control section 40 has been controlling the operating member 12 to provide a stimulus to the driver for a certain period of time, it suspends the generation of haptic information predetermined time in order to prevent the driver from becoming immune to the stimulus.

Otherwise, during haptic stimulus generation mode, the control section 40 generates haptic information according to the state of the vehicle that it received and controls the driving section 20 based on the haptic information to cause the operating member 12 to operate to provide a predetermined haptic stimulus to the driver touching the operating member 12. For example, the operating member 12 may generate an X-axis vibration stimulus for “failure to turn off lights”, a Y-axis vibration stimulus for “fuel level low”, and a 45-degree-from-X-axis vibration stimulus for “tire pressure low”. This allows the driver, using their knowledge of the meanings of the various stimuli, to understand the state of the vehicle from the stimulus through his or her sense of touch without visually checking a light switch or instrument panel. The haptic stimulus provided to the driver through the operating member 12 is not limited to vibration. For example, it may be any other motion represented by two-dimensional figures such as a circle, square, or triangle.

According to the present embodiment, the status of the vehicle can be indicated to the driver through his or her sense of touch without recourse to his or her sense of vision. In addition, different patterns can be generated by the haptic interface device 2 according to information to be provided, thereby providing the advantage that the number of operating switches on on-vehicle devices can be reduced.

Second Embodiment

The first embodiment has been described with respect to the apparatus for indicating a detected state of the vehicle to the driver. A second embodiment will be described below with respect to an apparatus capable of detecting circumstances outside a vehicle and indicating this information to a driver. A state sensor unit 4 according to the second embodiment is provided as state sensing means for sensing circumstances outside a vehicle. Other components of the present invention are the same as those of the first embodiment as described above with reference to FIGS. 1 to 5.

The term “circumstances outside a vehicle” refers to phenomena or current circumstances such as the direction and force of wind, the angle of incline of a road, conditions of a road surface, an obstacle in the vehicle path, and lane deviation external to the vehicle, and which should preferably be indicated to the driver. They are essentially phenomena at an alert level or higher. For example, the state sensor unit 4 may include an anemometer and an anemoscope for sensing the force and direction of wind in order to supply data on the velocity and direction of wind. The state sensor unit 4 may also comprise a vehicle inclinometer for sensing the inclination of a sloping road in order to supply data on inclination direction and angle of the inclination.

An operation according to the present embodiment is the same as that of the first embodiment. That is, when data on circumstances outside a vehicle as measured by the state sensor unit 4 is received via the connection line 6, a control section 40 determines whether or not it should generate haptic information. When the control section 40 determines that haptic information should be generated, the control section 40 generates the appropriate haptic information corresponding to the received information regarding the state outside the vehicle, and controls a driving section 20 based on the haptic information to cause an operating member 12 to operate to provide a predetermined haptic stimulus to a driver who is in contact with the operating member 12.

For example, when wind velocity and wind direction data is sent from the state sensor unit 4, the control section 40 controls the driving section 20 to generate vibration stimulus with amplitude proportional to the wind velocity in a direction corresponding to the wind in the positive direction of the X-axis corresponding to the travel direction of the vehicle. When inclination direction and inclination angle data is sent from the state sensor unit 4, the control section controls the driving section 20 to generate a haptic stimulus according to the direction and angle. A sensor installed in the vehicle senses a lane marker provided on the surface of a road to obtain information about the position of the vehicle in the lane. The control section controls the driving section 20 so as to generate vibration stimulus moving from side to side for indicating lane deviation of a vehicle. The detection of the position in the lane may be achieved by detecting a lane marker by means of an on-vehicle camera or by detecting a magnetized lane marker by means of a magnetometric sensor on the vehicle body.

Thus, the driver, using their knowledge about the meaning of various stimuli, can understand the state outside the vehicle through his or her sense of touch based on the type of the haptic stimulus provided. Therefore, the driver can obtain information, such as the velocity of wind, that he or she cannot obtain from inside the vehicle. The haptic stimulus provided to the driver through the operating member 12 is not limited to vibration. It may be any other motion that can be represented by two-dimensional figures such as a circle, square, or triangle.

Information about a state outside the vehicle may be obtained not only on-vehicle sensors but also equipment provided outside the vehicle. For example, if the state sensor unit 4 includes a receiver for receiving information from a system such as an Advanced Cruise-Assist Highway System (AHS) that has a cruise assist function for providing information to the vehicle, providing an alert, and assisting the operation of the vehicle, a road infrastructure sensor senses an obstacle such as a parked car or a fallen object and sends information through an AHS beacon. The state sensor unit 4 uses the receiver to receive the obstacle data sent from the beacon, upon receipt of which the control section 40 controls the driving section 20 to generate haptic information that provides a predetermined vibration stimulus in the direction that imitates the travel direction of the vehicle. When road surface conditions such as icy road conditions are indicated to the vehicle, the control section 40 controls the driving section 20 to generate haptic information for providing a predetermined vibration stimulus in a long elliptic motion, in the travel direction of the vehicle. In this way, an information receiver for receiving traffic information sent by a service provider as a state outside the vehicle may also be provided to obtain information about the conditions outside the vehicle besides an on-vehicle sensor.

According to the present embodiment, conditions outside the vehicle can be indicated to the driver through their sense of tough without help of vision. Haptic information generated for providing information to the driver can be presented to him or her in an intuitive and clear manner by moving the operating member 12 in the direction corresponding to a phenomenon or information to be indicated to him or her to produce a stimulus such as a stimulus moving back and forth for indicating the presence of an obstacle ahead or a stimulus moving from side to side for indicating lane deviation.

While the first embodiment was described with respect to the detection of a state of the vehicle and the second embodiment has been described with respect to the detection of conditions outside the vehicle, means for detecting the states of both of the state of the vehicle and conditions outside the vehicle may be provided in combination to allow the device to address either or both.

Third Embodiment

Some events or conditions, such as hard braking, a sharp turn, or a crash, require that the driver grip the steering wheel to take action or support themselves. When a haptic interface device 2 is provided at a position on a steering wheel where a driver as shown in FIG. 4, to the device may interfere with the driver's gripping of the steering wheel 8 because the operating member 12 is essentially in a movable state. In a third embodiment, immobilization means are provided to forcefully place a moving member in an immovable state when a condition such as hard braking, a sharp turn, a crash, or the like requires strong gripping of the steering wheel.

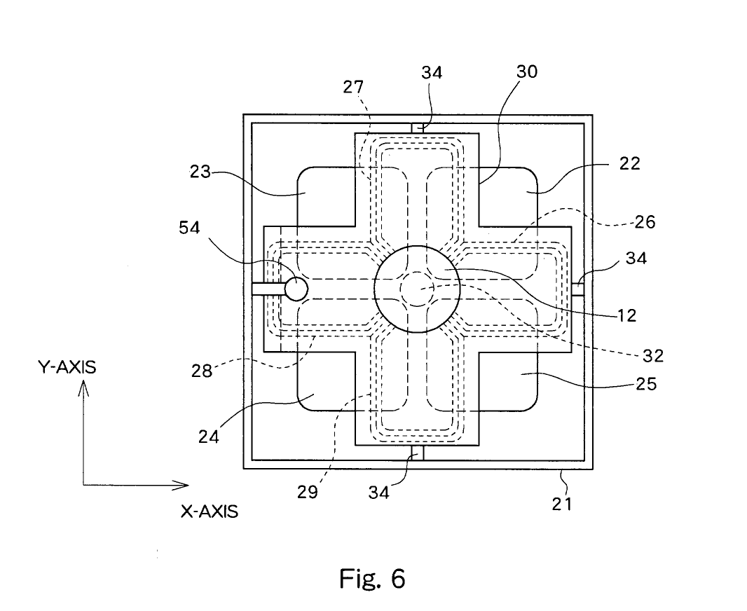

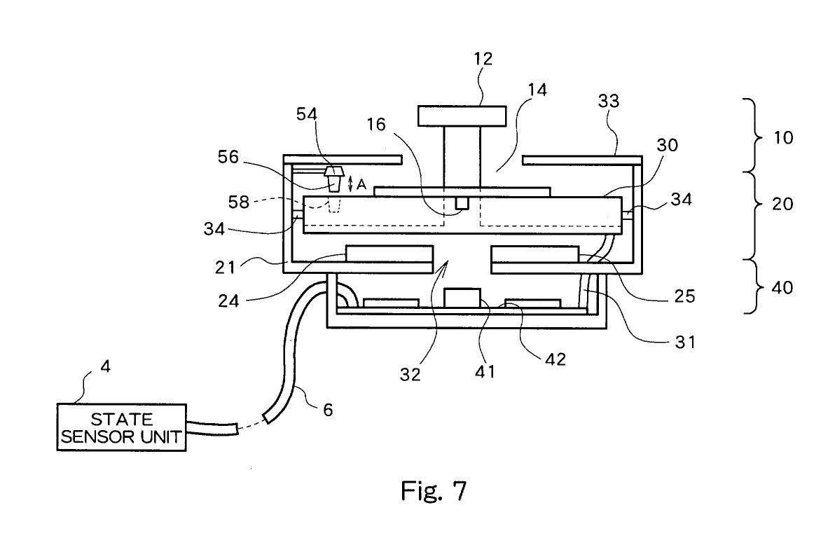

FIG. 6 shows a plan view of a haptic interface device of the third embodiment, with the top of its housing being removed. FIG. 7 shows a side elevation view of the haptic interface device shown in FIG. 6. The same components as those in the above-described embodiments are labeled with the same reference numerals and their description will not be repeated.

A solenoid 54 is fixed to the case 21 of a driving section 20 in the present embodiment. A solenoid moving part 56 of the solenoid 54 moves away from a frame 30 (toward the top of the drawing) when the power supply is off and approaches the frame 30 (moves toward the bottom of the drawing) when the power supply is on. In the power-on state, the solenoid moving part 56 continues to descend, toward the bottom of the drawing, to fit into a locking hole 58 provided in the top surface of the frame 30. According to the present embodiment, this structure forms a lock mechanism for physically immobilizing a movable state of the moving member. Locking by this lock mechanism is controlled by a control section 40.

An example operation of the present embodiment will be described below. A state sensor unit 4 determines whether or not a condition that requires strong hold of the steering wheel for hard braking has occurred. When it is determined that strong gripping may be required, the state sensor unit 4 outputs a signal indicating that immobilization is required. The control section 40 receives this immobilization signal from the state sensor unit 4 and powers the solenoid 54. This causes the solenoid moving part 56 to move toward the frame 30 to fit into the locking hole 58. Because the movement of the frame 30 is then physically inhibited by the solenoid moving part 56, the operating member 12 does not move relative to the steering wheel when gripped.

Thus, according to the present embodiment, the moving members can be forcedly immobilized.

Assuming that the frame 30 is at a neutral position when it is not driven by the control section 40, the frame 30 in an unlocked state is not always positioned at the neutral position because it is driven by the control section. When the frame 30 is not at the neutral position, a solenoid moving part 56 moving toward the frame 30 cannot lock the frame 30 because the locking hole 58 is not positioned at the corresponding position. Therefore, the control section 40, which would otherwise control the frame 30 to move back to the neutral position when it receives an immobilization signal from the state sensor unit 4 so that the solenoid moving part 56 locks into the locking hole 58, controls the solenoid 54 so that the top surface of the frame 30 is pressed against the solenoid moving part 56 if the frame 30 is not returned to the neutral position. If the frame 30 has not returned to the neutral position, the control section 40 inhibits the movement of the frame 30 by a pushing force, rather than moving it back to the neutral position.

While the solenoid 54 is provided to immobilize the frame 30 from above in the present embodiment, a locking hole may be provided in one side or the bottom of the frame 30 to immobilize it from the side or bottom. Furthermore, while the frame 30, which is a moving member, is immobilized in the present embodiment, immobilization means may be provided that immobilizes the operating member 12, instead of the frame 30, provided that the operating member 12 is not moved by a holding force exerted by the driver.

Fourth Embodiment

In the embodiments described above, operating member 12 is moved in two dimensions, two directions within a plane, to provide haptic stimuli to the driver. A fourth embodiment is characterized in that a two-degree-of-freedom haptic interface device is provided to allow three-dimensional haptic stimuli to be provided to the driver.

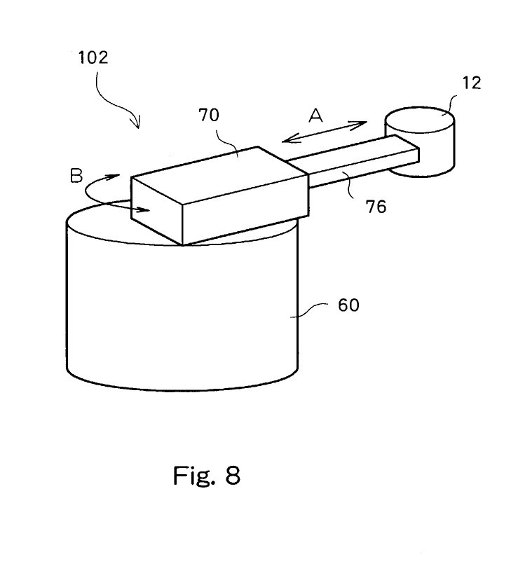

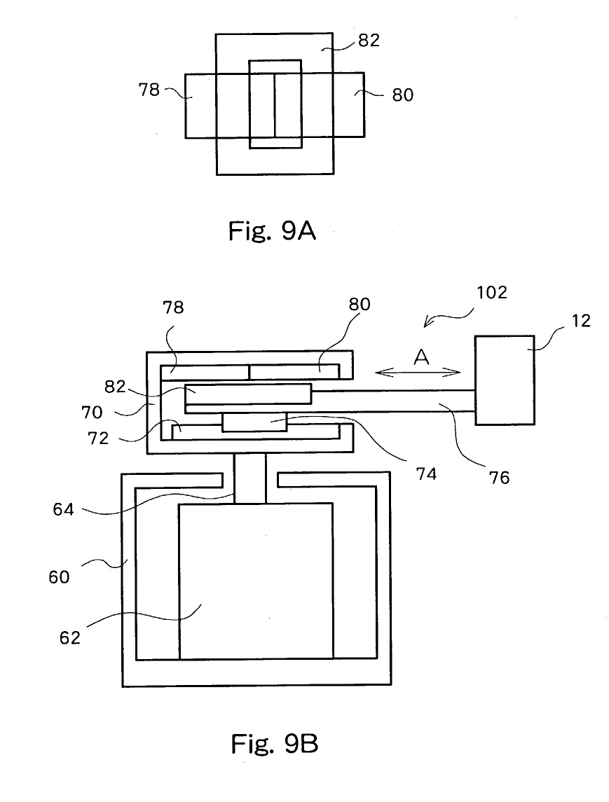

FIG. 8 shows a schematic perspective view of a haptic interface device according to the fourth embodiment. FIG. 9A is a view showing a physical relationship between a coil and a magnet in the haptic interface device shown in FIG. 8 viewed from above. FIG. 9B is a side elevation view showing a configuration of the haptic interface device shown in FIG. 8 with a part of its housing removed. The configurations of a state sensor unit and control section are the same as those of the first embodiment and therefore they are omitted from these drawings.

Two stacked housings 60 and 70 are shown in the drawings. A rotary motor 62 is contained in the housing 60 as shown in FIG. 9B. The rotating shaft 64 of the rotary motor 62 is coupled to the housing 70. The housing 70 contains a rail 72 provided at the bottom of the housing, a slider 74 sliding on the rail 72, and an arm 76 fixed to the slider 74 and extending from an opening in one side of the housing 70. Magnets 78 and 80 are attached to the internal side of the top plate of the housing 70. The magnets 78 and 80 are provided in such a manner that their polarities are opposite to each other. A coil 82 is provided on the arm 76 facing the magnets 78 and 80. The coil 82 is electrically connected to a control circuit (not shown) through a signal line, which is not shown. An operating member 12 is attached to the tip of the arm 76 extending from the housing 70.

The haptic interface device 102 according to the present embodiment has a combined configuration in which the rotary motor and the linear motor are as described above. The haptic interface device 102 is embedded in a steering wheel in such a manner that only the operating member 12 projects from the steering wheel. To enable movement of the operating member 12 in three-dimensions, a notch is provided in the surface of the steering wheel and a hollow space is provided inside the steering wheel.

The functional block configuration according to the present embodiment is the same as that of the first embodiment shown in FIG. 5. FIGS. 8 and 9 show only the configuration of a haptic presentation unit 52. An indication control unit 50 generates haptic information based on the status of the vehicle or conditions outside the vehicle sent from a state sensor unit 4 and controls the haptic presentation unit 52, when required. The same process as in the first embodiment is performed in the state sensor unit 4 and the indication control unit 50, in which the haptic presentation unit 52 is driven according to a state of the vehicle or conditions outside the vehicle detected by the state sensor unit 4. Therefore, only operations of the haptic presentation unit 52 shown in FIGS. 8 and 9 under the control of a control section will be described here.

Under the control of the control section, the rotary motor 62 rotates the rotating shaft 64 to turn the housing 70 coupled to the rotating shaft 64 in the direction indicated by arrow B. This can move the operating member 12 in the direction of the rotation. When an electric current is passed through the coil 82 in a predetermined direction under the control of the control section, the slider 74 in a movable state slides on the rail 72 according to Fleming's left-hand rule. This causes the arm 76 to move with the sliding of the slider 74 in the direction along the rail 72 (the direction indicated by arrow A). When viewed from the housing 70, the arm 76 looks like expanding and contracting in the direction indicated by arrow A. In this way, the operating member 12 can be moved in the linear directions.

According to the present embodiment, the two-degree-of-freedom haptic interface device is provided to allow complex haptic stimuli to be provided to the driver.

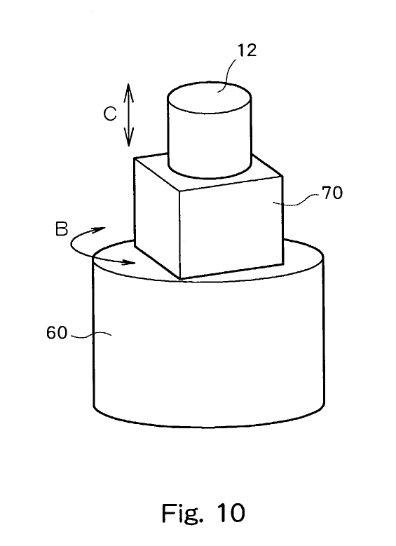

In the structure described with reference to FIG. 8, the arm 76 moves in the direction along the circumference of the steering wheel. The arm 76 can be arranged so as to move in directions approximately orthogonal to the circumference of the steering wheel. FIG. 10 shows a schematic perspective view of a haptic interface device equivalent to the one shown in FIG. 8. Rather than connecting the rotating shaft of a rotary motor contained in the housing 60 to the housing 70, the rotating shaft can be arranged so as to change its rotation direction by 90 degrees by means of a bevel gear to provide a haptic interface device that moves its operating member 12 up and down (in the direction indicated by arrow C). While the present embodiment is described with respect to a two-degree-of-freedom haptic interface device by way of example, the device according to the present invention may have more than two degrees of freedom. In such a case, more information can be provided to the driver and the operating member can be caused to perform an action according to information to be indicated to the driver or moved in a direction relating to the information to be indicated to the driver. Thus, a more intuitive haptic presentation can be achieved.

While the haptic interface device suited to be embedded in the steering wheel of a vehicle has been described, the present embodiment is not limited to this. The haptic interface device can, for example, be applied to devices other than steering wheels or devices other than vehicles.

What is claimed is:

1. A haptic interface device comprising:
state sensing means for sensing at least one of a state of a vehicle and a state outside the vehicle;
indication control means for determining whether or not information sensed by said state sensing means should be indicated to an operator and for generating haptic information representing said information when it determines that the information should be indicated to the operator; and
haptic experience presentation means for moving based on the haptic information provided from said indication control means.

2. The haptic interface device according to claim 1, wherein said haptic presentation means has two or more degrees of freedom of movement].

3. The haptic interface device according to claim 2, wherein said haptic experience presentation means comprises:
a base member;
an operating member to be operated by the operator;
a moving member movably attached to said base member and to which said operating member is fixed; and
operating member drive control means for driving said operating member in at least two degrees of freedom by moving said moving member drive; and
said operating member control means controls said moving member in a movement pattern according to information to be provided to the operator.

4. The haptic interface device according to claim 3, further comprising immobilization means for forcibly immobilizing said moving member when a condition which may require strong gripping of a steering wheel on which the haptic interface device is installed is detected.

5. The haptic interface device according to claim 4, wherein
said immobilization means has a lock mechanism for physically inhibiting a movable state of said moving member.

6. The haptic interface device according to claim 3, wherein
said operating member drive control means drives said operating member in a direction relating to information to be indicated to the operator as haptic information.

7. The haptic interface device according to claim 1, wherein
said state sensing means has an information receiving unit for receiving traffic information sent from a provider as a state outside the vehicle.
